(19) United States
(12) Patent Application Publication
(10) Pub. No.: US 2006/0245299 A1
(43) Pub. Date: Nov. 2, 2006

(54) Tube mixer having a longitudinal built-in body

(76) Inventors: Rolf Heusser, Winterthur (CH); Nicklaus Brugner, Ziemetshausen (DE); Sandro Martino, Winterthur (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/474,152

(22) Filed: Jun. 22, 2006

Related U.S. Application Data
(62) Division of application No. 10/242,934, filed on Sep. 13, 2002.

(30) Foreign Application Priority Data
Mar. 22, 2002 (EP) 02405221.9

(51) Int. Cl. A47J 31/12; B01F 5/06

(52) U.S. Cl. 366/336; 366/601

(57) ABSTRACT

The tube mixer includes a longitudinal built-in body (1) with which a laminar mixing process can be brought about in a medium (A, B) flowing through the mixer in a laminar manner. The tube mixer has a hybrid structure. At least two longitudinal sections (Q, X) are combined which have different mixer structures. A mix-resistant strand, which results in the laminar mixing process in the medium to be mixed, can be associated with a first section which has a first structure. A further mix-resistant strand can be associated with a second section which is adjacent to the first section and has a second structure. The mix-resistant strands are offset transversely with respect to one another at the transition between the two sections.

The invention relates to a tube mixer having a longitudinal built-in body in accordance with the preamble of claim 1 and to applications of the mixer.

A static mixer for the carrying out of a laminar mixing process is known from EP-A-1 125 625 in which high viscosity materials such as sealants, two-component foams or two-component adhesives are mixed. This mixer can be used as a “disposable mixer” for one-time use. It is a tube mixer having a longitudinal built-in body which has a special structure. This mixer structure is derived from a basic structure by modifications. The aim of the modifications is to influence “mix-resistant flow threads”, which occur in a laminar mixing process carried out with the basic structure, for the purpose of improving the mixing result. The term “mix-resistant flow thread”, which is termed a “mix resistant strand” in the following, relates to the phenomenon that there are flow threads which, comprising only one of the components to be mixed, run through the mixer structure and in this connection undergo practically no blending, or only insufficient blending, with adjacent flow threads.

It is the object of the invention to provide a tube mixer having a longitudinal built-in body in which the occurrence of a mix-resistant strand is suppressed by further measures. This object is satisfied by the tube mixer defined in claim 1.

The tube mixer contains a longitudinal built-in body with which a laminar mixing process can be brought about in a medium which flows through the mixer in a laminar fashion. The tube mixer has a hybrid structure. At least two longitudinal sections are combined which have different mixer structures. A mix-resistant strand, which results in the medium to be mixed in the laminar mixing process, can be associated with a first section which has a first structure. A further mix-resistant strand can be associated with a second section which is adjacent to the first section and which has a second structure. The mix-resistant strands are offset transversely with respect to one another at the transition between the sections.

Dependent claims 2 to 9 relate to advantageous embodiments of the tube mixer in accordance with the invention. An application possibility of the tube mixer in accordance with the invention is the subject of claim 10.

In an advantageous embodiment, the longitudinal built-in body has a hybrid structure which has differently structured sections. Mix-resistant strands can be associated with these sections which are offset transversely with respect to one another such that none of these strands forms a continuation to one respective mix-resistant strand which occurs in an adjacent section.

The invention will be explained in the following with reference to the drawings. There are shown:

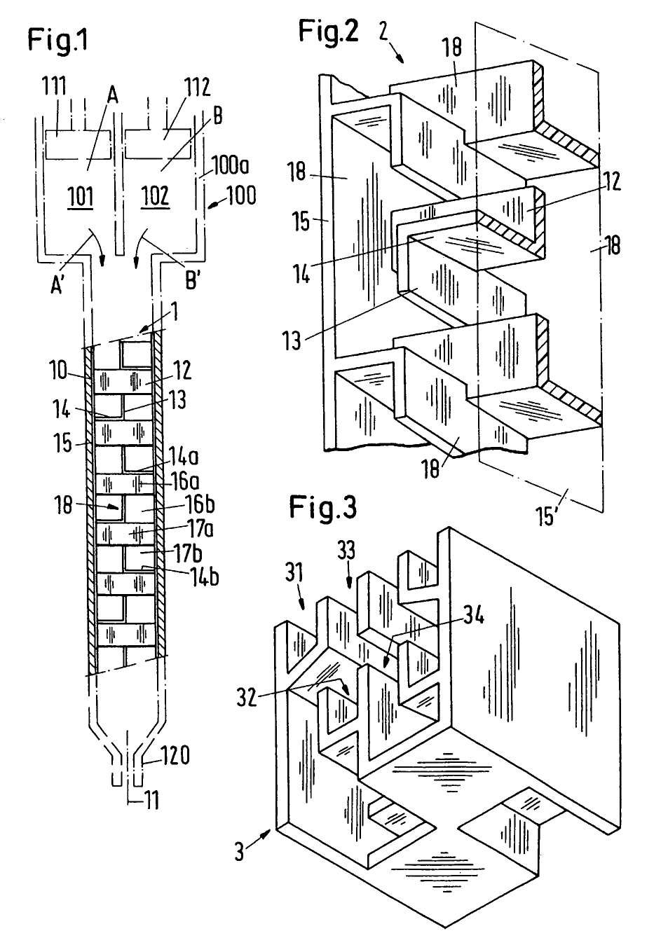

FIG. 1 a static mixer having a known, longitudinal built-in body which has a non-modified base structure and is part of an apparatus;

FIG. 2 a similar built-in body as in FIG. 1;

FIG. 3 a section of a built-in body which has a different mixer structure;

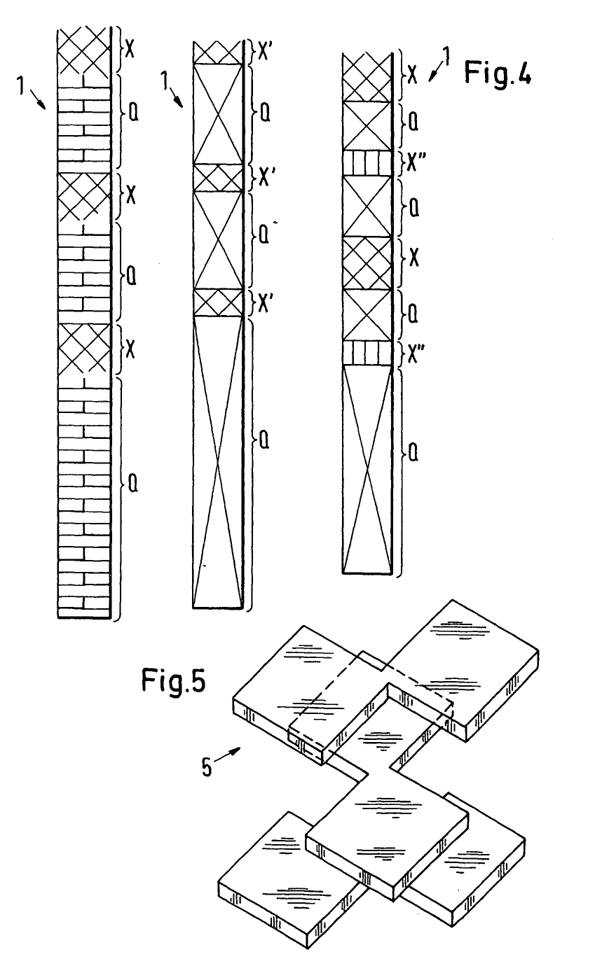

FIG. 4 three examples for hybrid structures in accordance with the invention in which different mixer structures are combined;

FIG. 5 a third mixer structure;

FIG. 6 elements of a “multiflux” mixer structure;

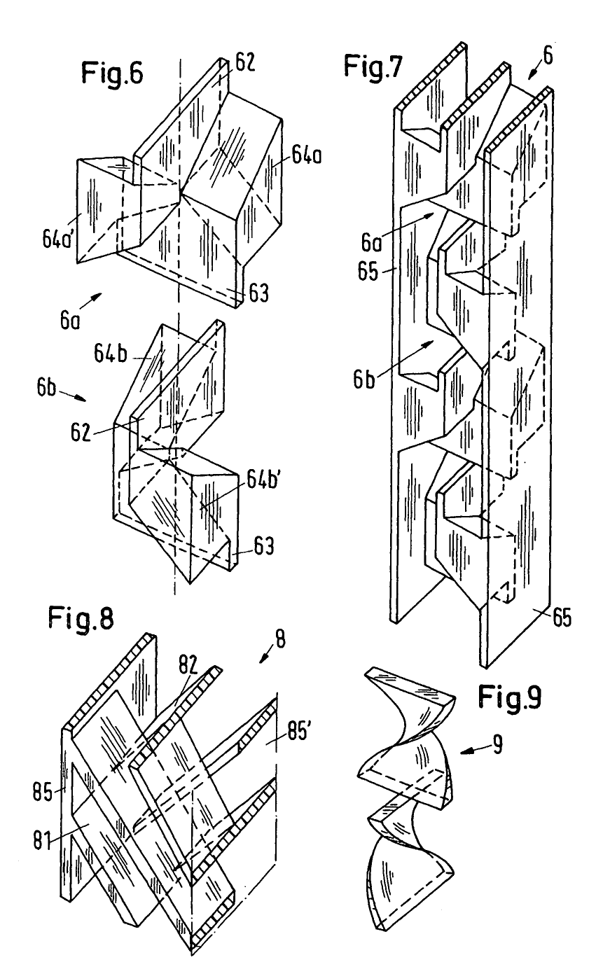

FIG. 7 a “multiflux” mixer structure;

FIG. 8 a mixer structure with crossing webs;

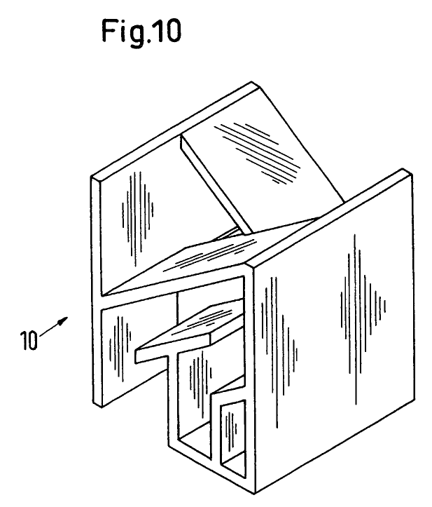

FIG. 9 a section of a known spiral mixer; and

FIG. 10 a further example of a hybrid structure section.

An apparatus 100 is indicated by chain-dotting in FIG. 1. This contains a static mixer having a longitudinal built-in body 1 by which a mixer structure is formed with a regular, non-modified basic structure. The mixer structure is illustrated in FIG. 1 as a side view and in FIG. 2—somewhat modified—as a perspective view from below. This basic structure is known from the publications EP-A-0 749 776 and EP-A-0 815 929 in which it has been described in two different ways: the basic structure is composed of a plurality of mixing elements which are arranged successively in a tube 10 (having a longitudinal axis or a longitudinal direction 11); or—in accordance with the second definition—it consists of a bundle of four chambered strings with mixing chambers 18 (“mix-effective chambers”) which extend in each case between two closed ends 14a and 14b and which are arranged offset with respect to adjacent chambers 18 in a longitudinal direction 11. Each of the mixing elements (first definition) includes two axial sections, with each of the sections being associated with a partition web 12 or 13 (radial walls) which divides the section. The partition webs 12, 13 cross and divide the tube cross-section into equally large part areas. The part areas are either open or covered by deflection plates 14.

The mixing chambers 18 of the basic structure (second definition) are of equal size and are arranged offset to one another. Two inlets 16a, 16b and two outlets 17a, 17b, which are arranged in an alternating sequence, form connections to four adjacent mixing chambers 18. Two lateral reinforcement walls 15 extend over the whole length of the longitudinal built-in body 1.

The built-in body 2 shown sectionally in FIG. 2 and represented with a view from below is rotated by 90° about the longitudinal axis 11 with respect to that of FIG. 1. FIG. 2 provides a more illustrative view of the structural elements, namely of the partition walls 12, 13 and of the deflection plates 14. Only one of the lateral reinforcement walls 15 is present. An inner surface 15′ of the other, cut-away wall is indicated in chain-dotted form. The section shown of the built-in body 2 contains two complete mixing chambers 18. The structure shown in FIGS. 1 and 2 is termed “structure Q” in the following. This structure Q, which is a regular basic structure, can also be structurally modified at places (cf. EP-A-1 125 625). The name “structure Q” should also additionally refer to the modified basic structure.

The apparatus 100 includes a two-chamber container 100a, namely a cartridge, comprising chambers 101 and 102. These serve for the separate reception of two free-flow components A and B. A and B can be pressed into the tube 10 (arrows A′, B′) through outlets of the tank 100a by means of pistons 111 and 112. After a mixing of A and B in the static mixer, which is composed of the tube 10 and the longitudinal built-in body 1 or 2, the mixture is discharged from the apparatus 100 through a nozzle 120. The cartridge 100a can include more than two chambers. The tube 10 is made as a tube part which can be placed onto the cartridge 100a.

Instead of the apparatus 100, a metering device can, for example, also be used in which the tube mixer in accordance with the invention is inserted. The components A and B are in this connection contained in separate containers from which they can be transported into the mixer by means of pumps, in particular of metering pumps.

FIG. 3 shows—with a view from below—an element 3 which represents a new, somewhat more complicated example of a mixer structure. This element 3 is provided for the purpose of forming the hybrid structure in accordance with the invention, for example, in combination with the known structure Q. The visible part of the element 3 with U-shaped transverse passages 31 and 32 extends up to a longitudinal central plane. The structure is made inversely to the visible part at the opposite side behind this central plane so that the transverse passages 31 and 32 each merge in their extensions into openings at the opposite side. These openings correspond to openings 33 and 34 at the visible side.

In the three examples of FIG. 4, hybrid structures in accordance with the invention are shown which are given by combinations of structure Q with structures X, X′ and X″. Structure X can be a so-called “SMX” structure; this is illustrated in FIG. 8. Structure X can, however, also be the element 3 of FIG. 3 or a plate arrangement 5, as is illustrated in FIG. 5, namely a modified structure Q, in which the partition webs 13 and 14 have been removed and which includes a plurality of mixing elements (in accordance with a first definition). Structure X′ in FIG. 4 corresponds to the lower half of structure X. Structure X″ has two webs which lie on two crossing planes in an alternating arrangement. The crossing lines of these planes lie on a longitudinal central plane which is parallel to the image plane. The webs are located at the lower side of the crossing line.

Said structure Q preferably includes, in built-in body 1, a portion which is dominant, which in particular—with respect to the length—is larger than 50%. Mix-resistant strands, which result in the sections having the structure Q, are resolved, or at least transversely dislocated, in subsequent structures X, X′ and X″ such that they no longer occur as mix-resistant strands in further sections.

It is advantageous for a structure X to be disposed in front of structure Q adjoining the cartridge 100a. For with an unfavourable orientation of structure Q with respect to the cartridge containers 101, 102, the entrance region of structure Q, which includes the first partition web 12 or 13, does not contribute anything to the mixing process. In structure X, the orientation has a smaller influence on the mixing effect.

The sections of the longitudinal built-in body 1 can be separate parts. It is, however, more advantageous for the built-in body 1 to form a cohesive piece in whole or in part, with this piece including a combination of at least two longitudinal sections. It is particularly advantageous for all sections together to form a monolithic built-in body 1 which can be produced by a casting method, which can in particular be produced by means of an injection moulding method from a thermoplastic.

It is known from the above-named EP-A-0 749 776 that the structure Q has a similarity to a so-called “multi-flux” mixer structure. The mixer structure 6 of FIG. 7 with the structural elements 6a, 6b shown in FIG. 6 is a structure Q converted into a “multi-flux” mixer structure 6. The longitudinal built-in body 1 of the tube mixer in accordance with the invention can sectionally include the mixer structure 6 instead of the structure Q or in addition to the structure Q. In the structural elements 6a, 6b, more voluminous bodies 64a, 64a′, 64b and 64b′ appear instead of the deflection plate 4 and each have the shape of two wedges placed on top of one another. In the mixer structure 6, the structural elements 6a, 6b form a dense sequence in an alternating arrangement between two side walls 65.

The element 8 shown in FIG. 8 has a structure (“SMX”) with webs 81, 82 which are inclined with respect to the longitudinal direction of the tube mixer. Adjacent webs 81, 82 are arranged in a crossing position. The front of two side walls 85 is cut away and indicated in chain dotting as an area 85′. The webs 81, 82 can be of different width so that gaps result between individual webs and the inner surface of the tube 10.

The tube mixer can also have a circular cross-section (cf. EP-A-0 749 776). In this case, sections with a known spiral structure 9—see FIG. 9—can also be used for the hybrid structure.

FIG. 10 shows a further example of a section which has a still not known mixer structure 10.

The tube mixture in accordance with the invention can be used to mix a high viscosity component A with at least one further component B in an apparatus 100—see FIG. 1. The further component B can have a viscosity lower by a factor of 10 to 1000 than the high viscosity component A. Or the mass flow of the further component B can be lower by a multiple than the mass flow of the high viscosity component A.

1-10. (canceled)

11. A method for using a tube mixer having a longitudinal built-in body within which a laminar mixing process can be brought about, wherein the body includes a hybrid structure having at least a first structure and a second structure different from the first structure, and is aligned along a longitudinal axis, the method comprising:
flowing a first mix-resistant strand in a first structure, said mix-resistant strand resulting in the medium to be mixed in the laminar mixing process; and
flowing a second mix-resistant strand in the second structure which is adjacent to the first structure,
wherein the first and second mix-resistant strands are offset transversely with respect to one another at the transition between the two structures.

12. The method of claim 111
wherein the first structure comprises partition webs and deflection plates substantially perpendicular to each other, wherein the partition webs and deflection plates define flow chambers, and wherein the deflection plates are substantially perpendicular to the longitudinal axis and the partition webs are substantially parallel to the longitudinal axis, and
wherein the second structure has a structure that includes one selected from the group consisting of (i) U-shaped passages, (ii) offset horizontal plates perpendicular to the longitudinal axis and being joined at corners of the plates, (iii) webs that are inclined with respect to the longitudinal axis and that lie in crossing planes in an alternating arrangement, and (iv) a spiral structure aligned along the longitudinal axis.

13. The method of claim 11, further comprising a cartridge comprising different viscosity components connected to the longitudinal body.

14. The method of claim 11 wherein the tube mixer comprises a high viscosity component (A) and at least one further component (B), wherein the further component has a viscosity smaller by a factor 10 to 1000 than the high viscosity component.

15. The method of claim 12 wherein a cross-section of the tube mixer is circular.

16. The method of claim 11 wherein the second structure comprises webs that are inclined with respect to the longitudinal axis.

17. The method of claim 11 wherein the second structure comprises the spiral structure aligned along the longitudinal axis.

18. The method of claim 11 wherien a cartridge is coupled to the longitudinal body, the cartridge comprising a first chamber and a second chamber.

19. The method of claim 18 wherein pistons are in the first and second chambers, and push components in the chambers.

20. The method of claim 18 wherein the first chamber contains a component A and the second chamber contains a component B, wherein component B has a viscosity lower by a factor of 10 to 1000 than component A.

21. The method of claim 1 the flowing first and second strands have a laminar profile.
